(19) United States
(12) Patent Application Publication
(10) Pub. No.: US 2010/0283174 A1
(43) Pub. Date: Nov. 11, 2010

(54) Fabrication of polymer grafted carbon nanotubes/polypropylene composite bipolar plates for fuel cell

(75) Inventors: Chen-Chi Martin Ma, Hsinchu (TW); Min-Chien Hsiao, Hsinchu (TW); Shu-Hang Liao, Hsinchu (TW); Jeng-Chih Weng, Hsinchu (TW); Shuo-Jen Lee, Taoyuan (TW); Ay Su, Taoyuan (TW)

Correspondence Address: BACON & THOMAS, PLLC, 625 SLATERS LANE, FOURTH FLOOR, ALEXANDRIA, VA, 22314-1176, US

(73) Assignee: YUAN ZE UNIVERSITY, Taoyuan (TW)

(21) Appl. No.: 12/591,026

(22) Filed: Nov. 5, 2009

(30) Foreign Application Priority Data
May 8, 2009 (TW) 98115463

(51) Int. Cl. B29C 43/02

(52) U.S. Cl. 264/105; 977/750; 977/752; 977/842

(57) ABSTRACT

A composite bipolar plate for a proton exchange membrane fuel cell (PEMFC) is prepared as follows: a) melt compounding a polypropylene resin and graphite powder to form a melt compounding material, the graphite powder content ranging from 50 wt % to 95 wt % based on the total weight of the melt compounding material and the polypropylene resin being a homopolymer of propylene or a random copolymer of propylene and ethylene, butylenes or hexalene, wherein 0.01-15 wt % of polymer-grafted carbon nanotubes by an acyl chlorination-amidization reaction, based on the weight of the polypropylene resin, are added during the compounding; and b) molding the melt compounding material from step a) to form a bipolar plates having a desired shaped at 100-250° C. and 500-4000 psi.

### FIELD OF THE INVENTION

The present invention relates to a method for preparing a fuel cell composite bipolar plate, and particularly to a method for preparing a fuel cell bipolar plate by a melt compounding process with polymer-grafted carbon nanotubes by acyl chlorination-amidization reaction, graphite powder and a thermoplastic resin.

### BACKGROUND OF THE INVENTION

U.S. Pat. No. 5,942,347 provides a bipolar separator plate suitable for use in a proton exchange membrane fuel cell produced by mixing at least one electronically conductive material, preferably a carbonaceous material, at least one resin, and at least one hydrophilic agent to form a substantially homogeneous mixture comprising the electronically conductive material in an amount in a range of about 50% to 95% by weight of the mixture, at least one resin in an amount of at least about 5% by weight of the mixture, and said at least one hydrophilic agent. The mixture is then molded into a desired shape at a temperature in a range of about 250° F. to 800° F., which temperature is a function of the resin used, and a pressure in a range of about 500 psi to 4,000 psi, resulting in formation of the bipolar plate. The resin used in this US patent can be selected from the group consisting of thermosetting resins, thermoplastic resins, and mixtures thereof, preferably a thermosetting resin. Suitable thermoplastic resins are polyvinylidene fluorides, polycarbonates, nylons, polytetrafluoroethylenes, polyurethenes, polyesters, polypropylenes, and HDPE. However, no example in this US patent shows polypropylene being used.

U.S. Pat. No. 4,214,969 discloses a fuel cell bipolar plate made of a polymer composite containing 74 wt % of graphite powder in polyvinylidene fluoride (PVDF) resin (Kynar®). This prior art bipolar plate has a flexural strength of 37.2 MPa and a electrical conductivity of 119 S/cm.

U.S. Pat. No. 7,056,452 discloses an electrically conductive composite as a fuel cell polar plate comprising a polyvinylidene fluoride (PVDF) polymer or copolymer and carbon nanotubes. Preferably, carbon nanotubes may be present in the range of about 0.5-20% by weight of the composite. The bipolar plate will has a decreasing volume resistivity when the content of carbon nanotubes increases, e.g. lower than 1 ohm-cm when the content of carbon nanotubes is 5 wt %, and about 0.08 ohm-cm as the content of carbon nanotubes is 13 wt %.

U.S. Pat. No. 6,746,627 discloses that composites containing polyvinylidene fluoride (PVDF) polymer or copolymer and carbon nanotubes have extraordinary electrical conductivity. PVDF or PVDF/hexafluoropropylene (HFP) copolymer composites with 13% or less by weight carbon nanotubes have an improved bulk resistivity. The PVDF/HFP copolymer has lower crystallinity than PVDF polymer. The bulk resistivity of the PVDF/HFP composite drops below 1 ohm-cm at 3.1% nanotube loading and the lowest reported bulk resistivity observed was 0.072 ohm-cm at 13.3% nanotube loading, which is within the range of bulk resistivity for a pure carbon nanotube mat. However, no improvement in bulk resistivity was observed for PVDF/HFP composites with more than 13.3% nanotube loading. PVDF/HFP composites with nanotube loadings up to approximately 3% appeared to have lower bulk resistivities than those of PVDF composites with the same nanotube loadings. Thus, at low nanotube loading, the conductivity of a PVDF composite may be improved by using a PVDF/HFP copolymer, or a lower grade PVDF with less crystallinity, instead of a pure PVDF polymer.

US patent publication No. 2004/0191608 discloses a method of making a current collector plate for use in a proton exchange membrane fuel cell, the method comprising the steps of: (a) molding by injection or compression molding a composition comprising from about 10 to about 50% by weight of a plastic, from about 10 to about 70% by weight of a graphite fibre filler, and from 0 to about 80% by weight of a graphite powder filler to form the current collector plate having two surface layers; (b) measuring the thickness of the current collector plate; and (c) removing the surface layers to reduce the thickness of the current collector plate by no more than about 10 micrometers. It was found that removing a much smaller layer from the surfaces of the molded plates may significantly increase the conductivity of molded polymeric current collector plates.

U.S. patent application Ser. No. 12/458,649, filed 20 Jul. 2009, commonly assigned to the assignee of the present application discloses a composite bipolar plate for a polymer electrolyte membrane fuel cell (PEMFC) is prepared as follows: a) melt compounding a polypropylene resin and graphite powder at 100-250° C. and 30-150 rpm to form a melt compounding material, the graphite powder content ranging from 50 wt % to 95 wt % based on the total weight of the graphite powder and the polypropylene resin, and the polypropylene resin being a homopolymer of propylene or a copolymer of propylene and ethylene, wherein 0.05-20 wt % carbon nanotubes, based on the weight of the polypropylene resin, are added during the melt compounding; and b) molding the melt compounding material from step a) to form a bipolar plate having a desired shaped at 100-250° C. and 500-4000 psi. Details of the disclosure in this US patent application are incorporated herein by reference.

U.S. patent application Ser. No. 12/457,353, filed 9 Jun. 2009, commonly assigned to the assignee of the present application discloses a process for preparing a composite bipolar plate for a polymer electrolyte membrane fuel cell (PEMFC) according to the present invention comprises: a) compounding vinyl ester and graphite powder to form bulk molding compound (BMC) material, the graphite powder content ranging from 60 wt % to 95 wt % based on the total weight of the graphite powder and vinyl ester, wherein 0.05-10 wt % reactive carbon nanotubes modified by acyl chlorination-amidization reaction, based on the weight of the vinyl ester resin, are added during the compounding; b) molding the BMC material from step a) to form a bipolar plate having a desired shaped at 80-200° C. and 500-4000 psi. Preferably, a metallic net such as stainless steel net is disposed in a mold in step so that the metallic net is embedded in the composite to enhance electrical conductivity, thermal conductivity and mechanical properties of the bipolar plate. A suitable process for preparing said reactive carbon nanotubes modified by acyl chlorination-amidization reaction comprises the following steps: 1) reacting carbon nanotubes with a strong acid under refluxing to form acidified carbon nanotubes; 2) reacting the acidified carbon nanotubes from step 1) with thionyl chloride (SOCl₂) to obtain acyl-chlorination carbon nanotubes having —COCl bounded to surfaces thereof; 3) conducting an amidization reaction between said acyl-chlorination carbon nanotubes and a polyamic acid resulting from a ring-opening reaction between a polyether amine and a dicarboxylic acid anhydride containing an ethylenically unsaturated group to obtain reactive carbon nanotubes modified by acyl chlorination-amidization reaction. Details of the disclosure in this US patent application are incorporated herein by reference.

To this date, the industry is still continuously looking for a small fuel cell bipolar plate having a high electric conductivity, excellent mechanical properties, a high thermal stability and a high size stability, which can be commercialized with a lower cost.

### SUMMARY OF THE INVENTION

One primary objective of the present invention is to provide a small size fuel cell bipolar plate having a high electrical conductivity, and excellent mechanical properties.

Another objective of the present invention is to provide a preparation method of a small size fuel cell bipolar plate having a high electrical conductivity, and excellent mechanical properties.

Another objective of the present invention is to provide a polymer-grafted nanotubes by acyl chlorination-amidization reaction and preparation method thereof.

In order to accomplish the aforesaid objectives a method for preparing a composite bipolar plate for a polymer electrolyte membrane fuel cell (PEMFC) according to the present invention comprises the steps as recited in Claim 1.

The method for preparing a composite bipolar plate for a polymer electrolyte membrane fuel cell (PEMFC) of the present invention uses a melt compounding material comprising a polypropylene resin, a conductive carbon, and carbon nanotubes. A suitable polypropylene resin used in the present invention is a semi-crystalline polypropylene resin having a crystallinity lower than 50%, preferably 30-50%, for examples a homopolymer of propylene or a copolymer of propylene and ethylene. The production cost of the bipolar plate according to the method of the present invention is reduced with a polypropylene resin which is cheap in price, by selecting a polypropylene resin having a suitable melt flow index and mechanical properties. Further, a melt compounding material with graphite powder and polymer-grafted carbon nanotubes uniformly dispersed in the polypropylene resin is formed according to the method of the present invention, which in turn renders the bipolar plate polyether prepared by the present invention has a high electrical conductivity, and excellent mechanical properties.

In one of the preferred embodiments of the present invention said polymer-grafted carbon nanotubes by acyl chlorination-amidization reaction was prepared by reacting acidified carbon nanotubes with thionyl chloride (SOCl₂) to obtain acyl-chlorination carbon nanotubes; and conducting an amidization reaction between said acyl-chlorination carbon nanotubes and an oligomer having a weight-averaged molecular weight of about 9000 (AEO2000) resulting from a ring-opening reaction between a polyether amine having a weight-averaged molecular weight of 2000 and an epoxy resin to obtain polymer-grafted carbon nanotubes by acyl chlorination-amidization reaction. The polymer-grafted carbon nanotubes by acyl chlorination-amidization reaction are able to be dispersed in the resin system and are reactive, so that a polypropylene/graphite composite bipolar plate having a high electrical conductivity and excellent mechanical properties was prepared, which has a volume conductivity greater than 400S/cm, a flexural strength as high as about 22 MPa and a impact strength as high as about 67 J/m. The volume conductivity greater than 400 S/cm is significantly higher than the technical criteria index of 100 S/cm of DOE of US.

In one of the preferred embodiments of the present invention said polymer-grafted carbon nanotubes by acyl chlorination-amidization reaction was prepared by reacting acidified carbon nanotubes with thionyl chloride (SOCl₂) to obtain acyl-chlorination carbon nanotubes; and conducting an amidization reaction between said acyl-chlorination carbon nanotubes and an oligomer having a weight-averaged molecular weight of about 1600 (AEO400) resulting from a ring-opening reaction between a polyether amine having a weight-averaged molecular weight of 400 and an epoxy resin to obtain polymer-grafted carbon nanotubes by acyl chlorination-amidization reaction. The polymer-grafted carbon nanotubes by acyl chlorination-amidization reaction are able to be dispersed in the resin system and are reactive, so that a polypropylene/graphite composite bipolar plate having a high electrical conductivity and excellent mechanical properties was prepared, which has a volume conductivity greater than 550 S/cm, a flexural strength as high as about 28 MPa and a impact strength as high as about 79 J/m. The volume conductivity greater than 550 S/cm is significantly higher than the technical criteria index of 100 S/cm of DOE of US.

Preferably, particles of said graphite powder have a size of 10-80 mesh. More preferably, less than 10 wt % of the particles of the graphite powder are larger than 40 mesh, and the remaining particles of the graphite powder have a size of 40-80 mesh.

### BRIEF DESCRIPTION OF THE DRAWINGS

FIG. 1 is FT-IR spectra of pristine Multi-Walled CNTs (abbreviated as MWCNT), and the polymer-grafted MWCNTs (abbreviated as MWCNT-AEO) of the present invention.

FIG. 2 is a plot of weight retention (%) versus heating temperature during thermogravimetric analysis (TGA) of pristine MWCNTs, and the polymer-grafted MWCNTs (MWCNT-AEO400 and MWCNT-AEO2000) of the present invention.

FIG. 3 is a current density versus voltage plot for single cells with bipolar plates prepared from graphite powder (inverted triangular points), PP/graphite powder/MWCNT (square points), PP/graphite powder/MWCNT-AEO2000 (triangular points), and PP/graphite/MWCNT-AEO400 (circular points).

### DETAILED DESCRIPTION OF THE INVENTION

The present invention provides a composite bipolar plate is produced by a melt compounding process using a polypropylene resin as a resin part of the composite. The polypropylene resin is a semi-crystalline resin comprising a homopolymer of propylene or a copolymer of propylene as a major portion and other ethylenically unsaturated monomer. The composite further comprises graphite power dispersed in the polypropylene resin to enhance the electrically conductivity of the composite and polymer-grafted carbon nanotubes blended therein as a reinforced material. The melt compounding process can be carried out by feeding the polypropylene resin, graphite powder and polymer-grafted carbon nanotubes to a brabender and operating the brabender at 100-250° C. and 30-150 rpm.

The polypropylene resin, polyether amines, and carbon nanotubes among other materials used in the following examples and controls are described as follows:
Polypropylene resin: Code PP4204 supplied from the Yung Chia Chemical Ind., Co., Ltd., Taiwan. PP4204 is ethylene-propylene copolymer having melt flow indices (MFI) of 19 g/10 min, and ethylene content of 14 wt %.
Graphite powder provide by Great Carbon Co. Ltd., Taiwan. Multi-Walled CNT (abbreviated as MWCNT) produced by The CNT
Company, Inchon, Korea, and sold under a code of C_{tube}100. This type of CNT was prepared by a CVD process. The CNTs had a purity of 95%, a diameter of 10-50 nm, a length of 1-25 μm, and a specific surface area of 150-250 m²g⁻¹.
Polyether diamines: Jeffamine® D-400 (n=5-6), Mw˜400, and Jeffamine® D-2000 (n=33), Mw˜2000, available from Hunstsman Corp., Philadelphia, Pa., having the following structure:

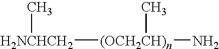

Maleic anhydride (abbreviated as MA) was obtained from Showa Chemical Co., Gyoda City, Saotama, Japan.
Epoxy resin: Diglycidyl ether of bisphenol A with an epoxide equivalent weight of 180 g/eq, abbreviated as DGEBA), supplied from Nan Ya Plastics Corporation, Taiwan:

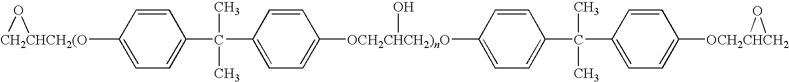

The present invention will be better understood through the following examples, which are merely illustrative, not for limiting the scope of the present invention.

### Preparation Example 1

### Reactive Carbon Nanotubes Modified by Acyl Chlorination-Amidization Reaction

Scheme 1 depicts an overview of procedures for preparing reactive carbon nanotubes modified by acyl chlorination-amidization reaction.

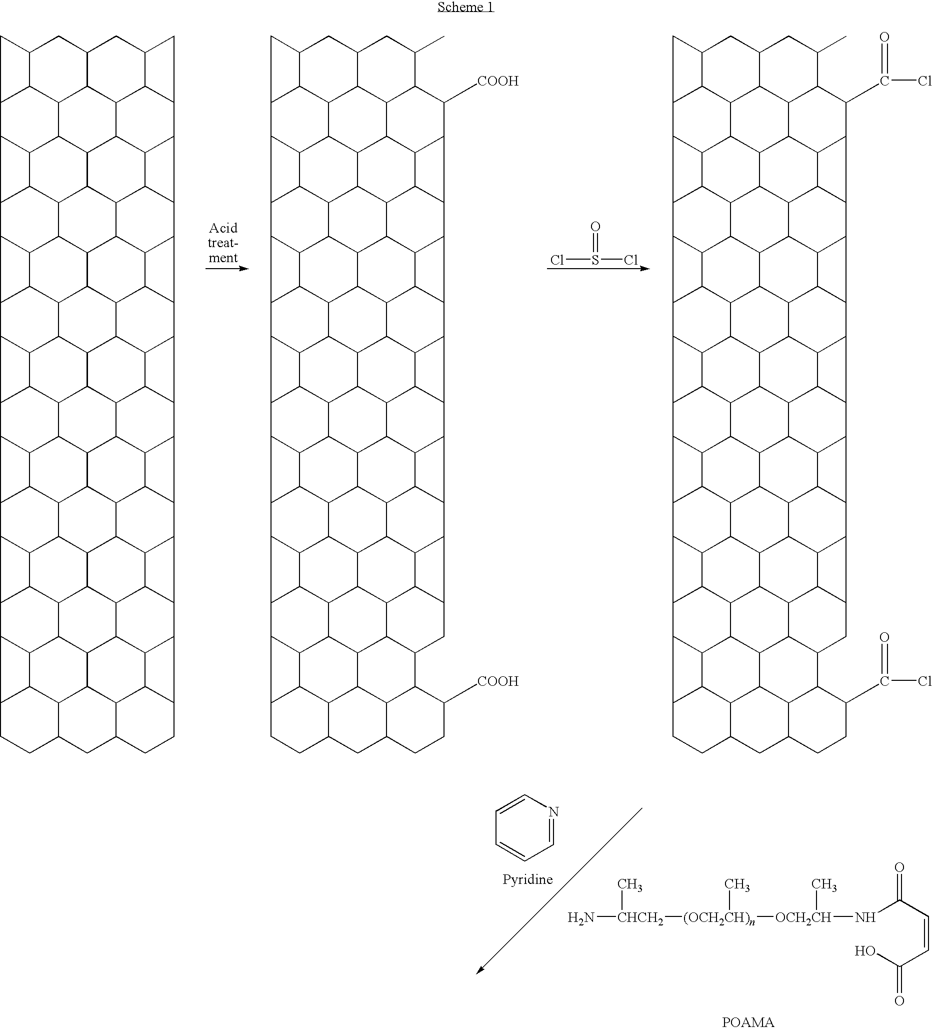

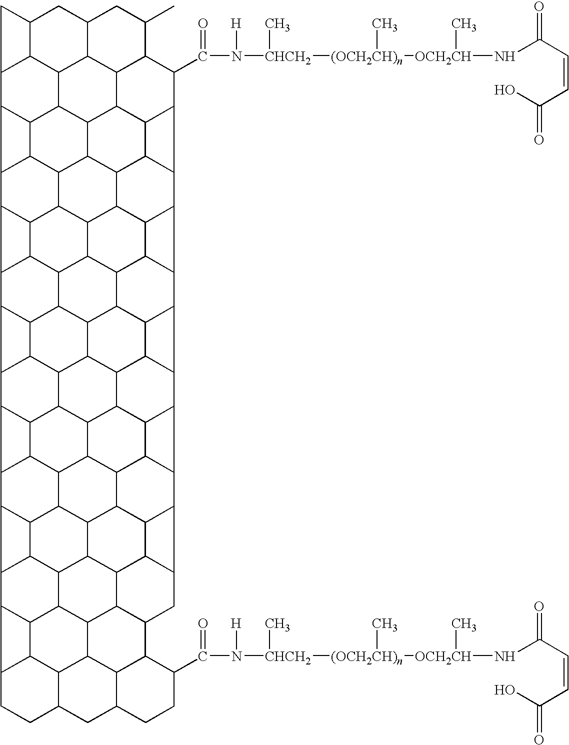

15.68 g (0.160 mole) of anhydrous maleic anhydride (MA) was slowly added to a reactor charged with 0.16 mole of poly(oxypropylene) diamine, Jeffamine® D-2000, and then stirred mechanically at 25° C. for 24 hours. The resulting product mixture was washed with deionized water several times, and dried at 100° C. to obtain maleic anhydride-polyether diamine (abbreviated as POAMA). 8 g MWCNTs and 400 mL of nitric acid were introduced into a three-neck flask, where an acidification was carried out under refluxing at 120° C. for 8 hours. The acidified MWCNTs were removed from the flask and washed with terahydrofuran (THF), dried at 100° C., and then introduced into another three-neck flask. Nitrogen was introduced into the flask after vacuuming, 300 ml thionyl chloride (SOCl₂) was starting to introduce into flask at a reaction temperature of 70° C. to undergo an acyl-chlorination reaction for 72 hours, followed by an amidization reaction at 90° C. for 24 hours by adding a pyridine solution of POAMA. The resulting product mixture was removed from the flask and washed with deionized water several times, and dried at 100° C. to obtain a final product of reactive carbon nanotubes modified by acyl chlorination-amidization reaction (MWCNTs/POAMA).

### Control Examples 1-5

The graphite powder used in this example consisted of not more than 10% of particles larger than 40 mesh (420 μm in diameter), about 40% of particles between 40 mesh and 60 mesh (420-250 μm in diameter), and about 50% of particles between 60 mesh and 80 mesh (250-177 μm in diameter).

Preparation of melt compounding material and specimen
1.10 g of polypropylene resin (PP4204), 40 g of the above-mentioned graphite powder and pristine carbon nanotubes (C_{tube 100}) with the amount listed in Table 1 were introduced into a brabender, where they were melt compounded at 180° C. and 50 rpm for 10 minutes. The melt compound material was removed from the brabender and cooled at room temperature.
2. The melt compound material was divided into several lumps, which were then pulverized in a mill for two minutes and half to form powders.
3. A slab mold was fastened to the upper and lower platforms of a hot press. The pre-heating temperature of the mold was set to 180° C. After the temperature had reached the set point, the powder was disposed at the center of the mold and pressed with a pressure of 1500 psi to form a specimen. After 30 minutes, the heater was turned off and the specimen was cooled in the mold to 80° C., which was then removed from the mold.

TABLE 1

| | | Amount added, |
|---|---|---|
| Control Ex. | Reinforced material | g (wt %)* |
| No. 1 | Pristine MWCNTs | 0 (0%) |
| No. 2 | Pristine MWCNTs | 0.1 (1%) |
| No. 3 | Pristine MWCNTs | 0.2 (2%) |
| No. 4 | Pristine MWCNTs | 0.4 (4%) |
| No. 5 | Pristine MWCNTs | 0.8 (8%) |

*% based on the weight of the polypropylene resin

### Examples A1-A4

### Polymer-Grafted Carbon Nanotubes by Acyl Chlorination-Amidization Reaction

Scheme 2 depicts an overview of procedures for preparing polymer-grafted carbon nanotubes by acyl chlorination-amidization reaction, wherein the rectangle in the formula of terminal-amine-containing oligomers (AEO400 and AEO2000) resulting from a ring-opening reaction between a polyether amine and an epoxy resin represents the underlined portion of the structure of DGEBA.

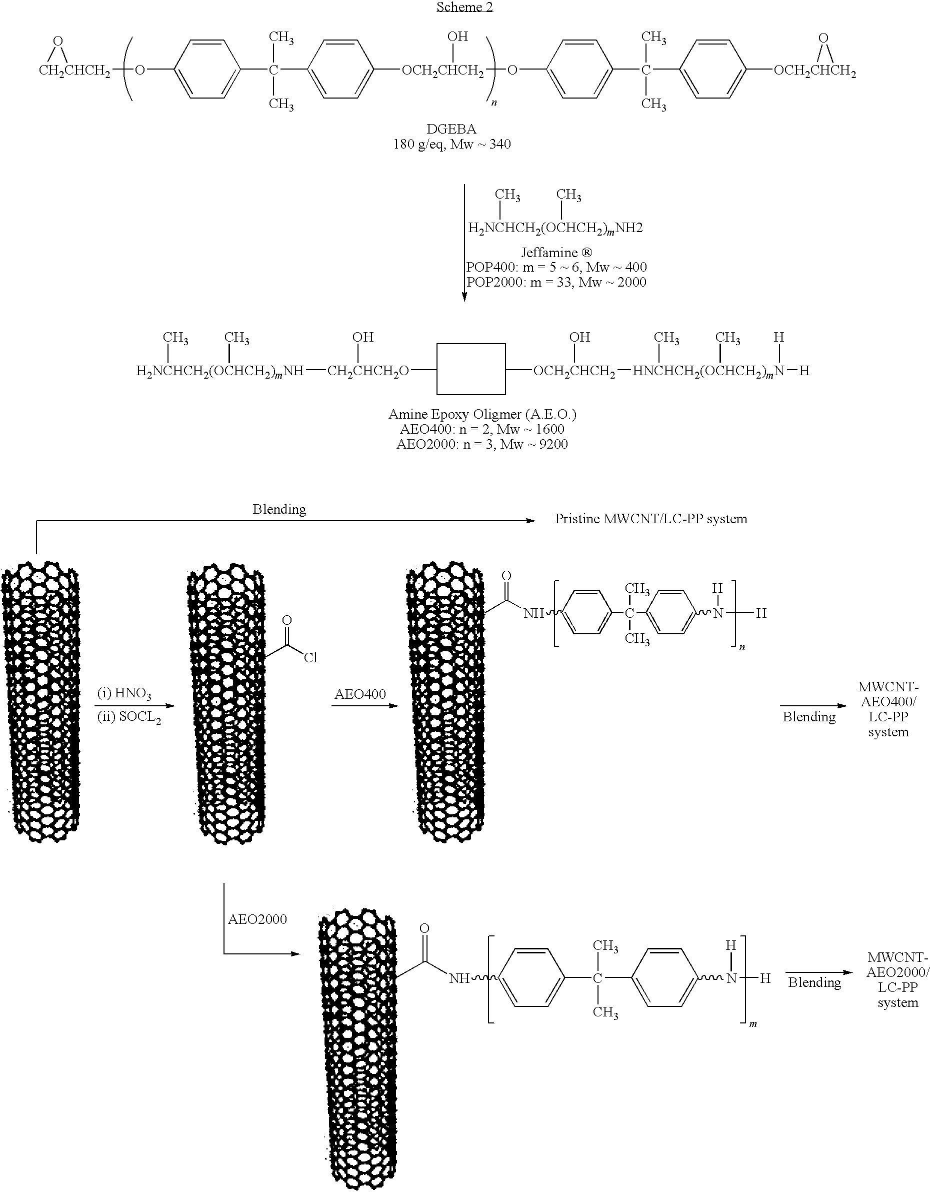

50 g of DGEBA was slowly added to a reactor charged with 88.2 g of poly(oxypropylene) diamine, Jeffamine® D-400, and then stirred mechanically at 60° C. for reacting 6 hours. The resulting product mixture was filtered and washed with deionized water several times to obtain a terminal-amino-containing oligomer (abbreviated as AEO400) from a ring-opening reaction between the polyether amine and the epoxy resin. The oligomer AEO400 has a weight-averaged molecular weigh Mw=1623 g mol⁻¹, and a number-averaged molecular weight Mn=697 g mol⁻¹, by HPLC analysis. 8 g MWCNTs and 400 mL of nitric acid were introduced into a three-neck flask, where an acidification was carried out under refluxing at 120° C. for 8 hours. The acidified MWCNTs were removed from the flask and washed with deionized water, dried at 100° C. to obtain acidified MWCNTs. 4 g of the acidified MWCNTs was then introduced into another three-neck flask. Nitrogen was introduced into the flask after vacuuming, 300 ml thionyl chloride (SOCl₂) was starting to introduce into flask when a reaction temperature of 70° C. was reached to undergo an acyl-chlorination reaction for 72 hours, followed by an amidization reaction at 70° C. for 24 hours by adding a pyridine solution of 2.4 g AEO400. The resulting product mixture was removed from the flask and washed with deionized water several times, and dried at 100° C. to obtain a final product of polymer-grafted carbon nanotubes by acyl chlorination-amidization reaction (abbreviated as MWCNT-AEO400).

The steps in Control Examples 1-5 were repeated to prepare lumps of molding material and specimens, except that the MWCNT-AEO400 prepared above in various amounts as listed in Table 2 was added together with the graphite powder to the brabender in step 1.

TABLE 2

| | | Amount added, |
|---|---|---|
| Example | Reinforced material | g (wt %)* |
| A1 | POP400-DGEBA grafted MWCNTs | 0.1 (1%) |
| | (MWCNT-AEO400) | |
| A2 | POP400-DGEBA grafted MWCNTs | 0.2 (2%) |
| | (MWCNT-AEO400) | |
| A3 | POP400-DGEBA grafted MWCNTs | 0.4 (4%) |
| | (MWCNT-AEO400) | |
| A4 | POP400-DGEBA grafted MWCNTs | 0.8 (8%) |
| | (MWCNT-AEO400) | |

*% based on the weight of the polypropylene resin

### Examples B1-B4

### Polymer-Grafted Carbon Nanotubes by Acyl Chlorination-Amidization Reaction

50 g of DGEBA was slowly added to a reactor charged with 370.4 g of poly(oxypropylene) diamine, Jeffamine® D-2000, and then stirred mechanically at 60° C. for reacting 6 hours. The resulting product mixture was filtered and washed with deionized water several times to obtain a terminal-amino-containing oligomer (abbreviated as AEO2000) from a ring-opening reaction between the polyether amine and the epoxy resin. The oligomer AEO2000 has a weight-averaged molecular weigh Mw=9231 g mol⁻¹, and a number-averaged molecular weight Mn=5838 g mol⁻¹, by HPLC analysis. 8 g MWCNTs and 400 mL of nitric acid were introduced into a three-neck flask, where an acidification was carried out under refluxing at 120° C. for 8 hours. The acidified MWCNTs were removed from the flask and washed with deionized water, dried at 100° C. to obtain acidified MWCNTs. 4 g of the acidified MWCNTs was then introduced into another three-neck flask. Nitrogen was introduced into the flask after vacuuming, 300 ml thionyl chloride (SOCl₂) was starting to introduce into flask when a reaction temperature of 70° C. was reached to undergo an acyl-chlorination reaction for 72 hours, followed by an amidization reaction at 70° C. for 24 hours by adding a pyridine solution of 13.7 g AEO2000. The resulting product mixture was removed from the flask and washed with deionized water several times, and dried at 100° C. to obtain a final product of polymer-grafted carbon nanotubes by acyl chlorination-amidization reaction (abbreviated as MWCNT-AEO2000).

The steps in Control Examples 1-5 were repeated to prepare lumps of molding material and specimens, except that the MWCNT-AEO2000 prepared above in various amounts as listed in Table 3 was added together with the graphite powder to the brabender in step 1.

TABLE 3

| | | Amount added, |
|---|---|---|
| Example | Reinforced material | g (wt %)* |
| B1 | POP2000-DGEBA grafted MWCNTs | 0.1 (1%) |
| | (MWCNT-AEO2000) | |
| B2 | POP2000-DGEBA grafted MWCNTs | 0.2 (2%) |
| | (MWCNT-AEO2000) | |
| B3 | POP2000-DGEBA grafted MWCNTs | 0.4 (4%) |
| | (MWCNT-AEO2000) | |
| B4 | POP2000-DGEBA grafted MWCNTs | 0.8 (8%) |
| | (MWCNT-AEO2000) | |

*% based on the weight of the polypropylene resin

### Identification of Polymer-Grafted MWCNTs

### Identification of Modified MWCNTs by FT-IR

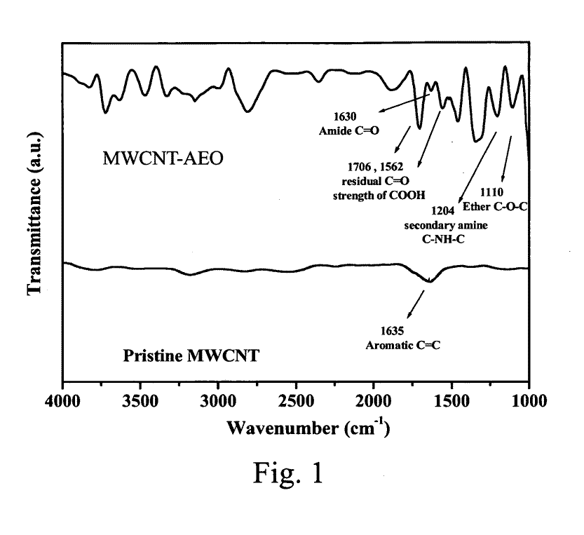

Pristine MWCNTs and the polymer-grafted MWCNTs (MWCNT-AEO) were subjected to FT-IR analysis to identify functional groups on surfaces thereof. It can be seen from FIG. 1 that the pristine MWCNTs show only one absorption peak of the benzene structure per se of the carbon nanotubes at 1635 cm⁻¹, however, the polymer-grafted MWCNT-AEO show an absorption peak of C—O—C segment at 1110 cm⁻¹, an absorption peak of C—NH—C bounding in AEO oligomer at 1204 cm⁻¹, an absorption peak of N—C═O bounding at 1603 cm⁻¹, and absorption peaks of residual non-reacted COOH groups at 1706 and 1562 cm⁻¹. The FT-IR spectra in FIG. 1 confirm that AEO oligomer has been successfully grafted onto the carbon nanotubes.

### Thermogravimetric Analysis (TGA) of Modified MWCNTs

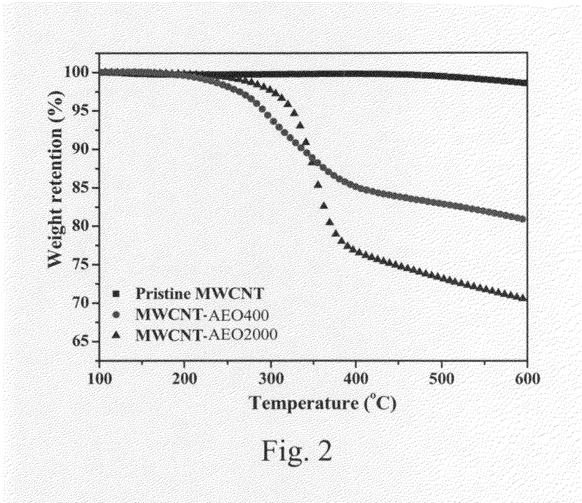

Organic molecules will decompose in advance to carbon nanotubes due to the relatively poor heat resistance of the organic molecules, when the polymer-grafted MWCNTS are subjected to a heat treatment. Accordingly, the content of organic molecules in the polymer-grafted MWCNTS is able to be calculated by TGA, wherein the polymer-grafted MWCNTS were heated to 600° C. at a rate of 10° C./min under a nitrogen atmosphere. The residual weight of the polymer-grafted MWCNTs was recorded versus the heating temperature, and the results thereof together with those of pristine MWCNTs are shown in FIG. 2. The content of organic molecules in the polymer-grafted MWCNTS was determined as the weight lost at 500° C. As shown in FIG. 2, the pristine MWCNTs have only 0.6 wt % lost at 500° C., indicating that MWCNTs are thermally stable. On the contrary, MWCNT-AEO400 and MWCNT-AEO2000 have 17.1 wt % and 27.8 wt % weight lost at 500° C., wherein the latter have a higher organic molecular content due to the molecular weight of AEO2000 being greater than that of AEO400.

### Electrical Properties:

### Test Method:

A four-point probe resistivity meter was used by applying a voltage and an electric current on the surface of a specimen at one end, measuring at the other end the voltage and the electric current passed through the specimen, and using the Ohm's law to obtain the volume resistivity (ρ) of the specimen according to the formula,

$$ρ = \frac{V}{I} * W * CF , \qquad ( formula 1 )$$

wherein V is the voltage passed through the specimen, I is the electric current passed through the specimen, a ratio thereof is the surface resistivity, W is the thickness of the specimen, and CF is the correction factor. The thermally compressed specimens from the examples and the control example were about 100 mm×100 mm with a thickness of 1.2 mm. The correction factor (CF) for the specimens was 4.5. Formula I was used to obtain the volume resistivity (ρ) and an inversion of the volume resistivity is the electric conductivity of a specimen.

### Results:

Table 4 shows the volume conductivity measured for the polymer composite bipolar plates prepared above, wherein the resin formulas are the same, and the content of graphite powder is 80 wt % with different amounts of pristine and polymer-grafted carbon nanotubes. The measured volume conductivity for the polymer composite bipolar plates increases as the content of the carbon nanotubes increases for Examples A1-A4 and B1-B4; however, for Control Examples 1-5 this trend stops at MWCNT content of 0.4 wt % (Control Example 4). The reason why the volume conductivity of Control Example 5 decreases is caused by the poor dispersion of MWCNTs in the polymer matrix as the level of MWCNT reaches 0.8 wt %, which typically appear as clusters in the polymer matrix, recognized as a lack of chemical compatibility. For pristine MWCNTs, the formation of local MWCNT aggregates tend to increase the number of filler-filler hops required to traverse a given distance, thus causing decreased in-plane electrical conductivity, i.e. increased resistivity. The driving force for better in-plane conductivity of polymer-grafted MWCNT polymer composite bipolar plates is better dispersion of polymer-grafted MWCNTs in the polymer matrix, due to the introduction of AEO oligomer grafted to the surface of MWCNTs. Well dispersed MWCNT-AEO inside the polymer matrix easily come into contact with each other and thus construct a much more efficient electrical network in the polymer composite bipolar plates. The volume conductivity of the bipolar plates using MWCNT-AEO400 (Examples A1-A4) is higher than that of using MWCNT-AEO2000 (Examples B1-B4), because the former has a greater number of oligomers grafted to the surface of MWCNTs, even though the latter has a longer polymer chain. Accordingly, in the MWCNT-AEO2000 case some of MWCNTs are not grafted with AEO2000 oligomers, and thus aggregate.

TABLE 4
Volume Conductivity (S/cm)

| Control Ex. 1 | Control Ex. 2 | Control Ex. 3 | Control Ex. 4 | Control Ex. 5 |
|---|---|---|---|---|
| 160 | 347 | 393 | 549 | 481 |
| Control Ex. 1 | Example A1 | Example A2 | Example A3 | Example A4 |
| 160 | 589 | 774 | 904 | 968 |
| Control Ex. 1 | Example B1 | Example B2 | Example B3 | Example B4 |
| 160 | 436 | 675 | 819 | 896 |

### Mechanical Property: Test for Flexural Strength

### Method of Test ASTM D790

### Results:

Table 5 shows the test results of flexural strength for polymer composite bipolar plates prepared above, wherein the resin formulas are the same, and the content of graphite powder is 80 wt % with different amounts of pristine and polymer-grafted carbon nanotubes. The measured flexural strength for the polymer composite bipolar plates increases as the amount of the MWCNTs increases. For the same content of MWCNTs the flexural strength of the polymer composite bipolar plates prepared in Examples A1-A4 is the highest, and Control Examples 1-5 is the lowest. It is believed that the AEO oligomers grafted to MWCNTs is reactive and compatible to the polymer matrix, and thus the polymer-grafted MWCNTs (MWCNT-AEO400 and MWCNT-AEO2000) are better dispersed in comparison with the pristine MWCNTs. As a result, the addition of polymer-grafted MWCNTs will better enhance the flexural strength of the bipolar plate in comparison with the addition of pristine MWCNTs. The flexural strength of the bipolar plates using MWCNT-AEO400 (Examples A1-A4) is higher than that of using MWCNT-AEO2000 (Examples B1-B4), because the former has a greater number of oligomers grafted to the surface of MWCNTs, even though the latter has a longer polymer chain. Accordingly, in the MWCNT-AEO2000 case some of MWCNTs are not grafted with AEO2000 oligomers, and thus aggregate. Examples A1-A4 (AEO400) have the best improvement in the flexural strength of bipolar plates in comparison with Examples B1-B4 and Control Examples 1-5, which exceeds the DOE target value (>25 MPa).

TABLE 5
Flexural Strength (MPa)

| Control Ex. 1 | Control Ex. 2 | Control Ex. 3 | Control Ex. 4 | Control Ex. 5 |
|---|---|---|---|---|
| 21.44 | 21.96 | 22.46 | 25.13 | 29.49 |
| Control Ex. 1 | Example A1 | Example A2 | Example A3 | Example A4 |
| 21.44 | 28.40 | 32.23 | 32.16 | 34.18 |
| Control Ex. 1 | Example B1 | Example B2 | Example B3 | Example B4 |
| 21.44 | 22.01 | 23.07 | 28.75 | 31.81 |

### Mechanical Property: Test for Impact Strength

### Method of Test: ASTM D256

### Results:

Table 6 shows the test results of notched Izod impact strength for polymer composite bipolar plates prepared above, wherein the resin formulas are the same, and the content of graphite powder is 80 wt % with different amounts of pristine and polymer-grafted carbon nanotubes. The measured notched Izod impact strength for the polymer composite bipolar plates increases as the amount of the MWCNTs increases. For the same content of MWCNTs the impact strength of the polymer composite bipolar plates prepared in Examples A1-A4 is the highest, and Control Examples 1-5 is the lowest. It is believed that the AEO oligomers grafted to MWCNTs is reactive and compatible to the polymer matrix, and thus the polymer-grafted MWCNTs (MWCNT-AEO400 and MWCNT-AEO2000) are better dispersed in comparison with the pristine MWCNTs. As a result, the addition of polymer-grafted MWCNTs will better enhance the impact strength of the bipolar plate in comparison with the addition of pristine MWCNTs. The impact strength of the bipolar plates using MWCNT-AEO400 (Examples A1-A4) is higher than that of using MWCNT-AEO2000 (Examples B1-B4), because the former has a greater number of oligomers grafted to the surface of MWCNTs, even though the latter has a longer polymer chain. Accordingly, in the MWCNT-AEO2000 case some of MWCNTs are not grafted with AEO2000 oligomers, and thus aggregate. Examples A1-A4 (AEO400) have the best improvement in the impact strength of bipolar plates in comparison with Examples B1-B4 and Control Examples 1-5, which exceeds the target value of Plug Power Co. (>40.5 Jm⁻¹).

TABLE 6
Impact Strength (J/m)

| Control Ex. 1 | Control Ex. 2 | Control Ex. 3 | Control Ex. 4 | Control Ex. 5 |
|---|---|---|---|---|
| 65.80 | 67.40 | 71.18 | 77.81 | 81.44 |
| Control Ex. 1 | Example A1 | Example A2 | Example A3 | Example A4 |
| 65.80 | 79.23 | 83.32 | 85.45 | 90.00 |
| Control Ex. 1 | Example B1 | Example B2 | Example B3 | Example B4 |
| 65.80 | 67.68 | 74.65 | 79.45 | 86.32 |

### Gas Tightness Test: UL-94 Test

### Method of Test:

Two chambers are separated by the bipolar plate prepared above, one of which is maintained at vacuum pressure, and another of which is maintained at a pressure of 5 bar. The gas tightness of the polymer composite bipolar plate is determined by observing the pressure changes in the two chambers.

### Results:

The bipolar plates in a PEMFC are gas flow fields, on which many delicate passages are formed. Hydrogen and air separately flow in the passages of two bipolar plates and diffuse through a gas diffusion membrane to MEA. The bipolar plate thus is required to have a good gas tightness to assure a high efficiency of the PEMFC.

Table 7 lists the gas tightness test results for the bipolar plates prepared above, wherein the resin formulas are the same, and the content of graphite powder is 80 wt % with different amounts of pristine and polymer-grafted carbon nanotubes. It can be seen from Table 7 that the polymer composite bipolar plates prepared in Control Examples 1-5 and Examples A 1-A4 and Examples B1-B4 all show no leaking in the helium gas tightness test (the detectable limit of the equipment is <1.5×10⁻⁹ cm³/cm²-sec). The vacuum chamber separated by the bipolar plate of the present invention show no detectable pressure change, indicating that the bipolar plate of the present invention has good gas tightness and is safe for use in the fuel cells. The good gas tightness of the bipolar plate of the present invention may be resulted from the thermoplastic resin used in the preparation of composite. The thermoplastic resin does not undergo a curing reaction during the hot-press molding, so that no vapor generates, and thus voids are prevented from forming in the resin matrix, thereby a tight formation without gas leaking can be obtained.

TABLE 7
Gas Tightness

| Control Ex. 1 | Control Ex. 2 | Control Ex. 3 | Control Ex. 4 | Control Ex. 5 |
|---|---|---|---|---|
| No leaking | No leaking | No leaking | No leaking | No leaking |
| Control Ex. 1 | Example A1 | Example A2 | Example A3 | Example A4 |
| No leaking | No leaking | No leaking | No leaking | No leaking |
| Control Ex. 1 | Example B1 | Example B2 | Example B3 | Example B4 |
| No leaking | No leaking | No leaking | No leaking | No leaking |

### Single Cell Performance Test

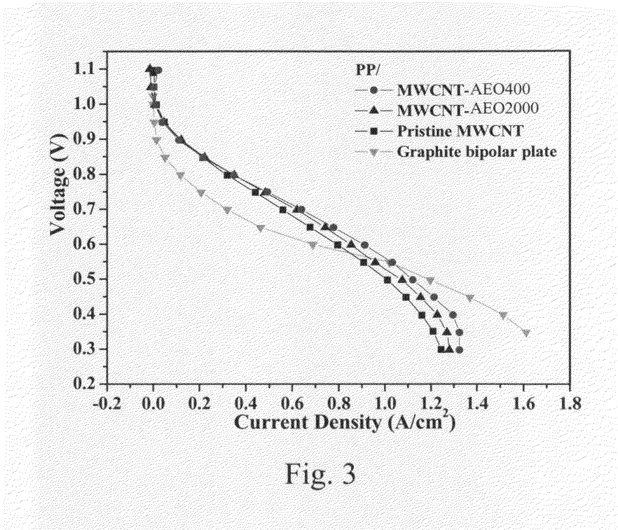

FIG. 3 shows the test results of current density versus voltage of a battery assembled with single fuel cells having polymer composite bipolar plates prepared above, wherein the resin formulas are the same, and the content of graphite powder is 80 wt % with 4 wt % of pristine and polymer-grafted carbon nanotubes. For comparison, the current density versus voltage curve of a battery assembled with single fuel cells having graphite bipolar plates is also shown in FIG. 3. The polarization curve of a fuel cell has the following relationship:

E=Eᵣ−ΔV_{act}−ΔVₒₕₘ−ΔV_{conc}

wherein E is the real voltage, Eᵣ is the theoretical voltage, ΔV_{act} is the activation overpotential, ΔVₒₕₘ is the ohmic overpotential for and ΔE_{conc} is the concentration overpotential.

As shown in FIG. 3 the maximum current density of the single cell having bipolar plates prepared with pristine MWCNTs, polymer-grafted MWCNTs MWCNT-AEO2000 and MWCNT-AEO400 are 1.245 A/cm², 1.281 A/cm² and 1.324 A/cm², respectively. Among them the MWCNT-AEO400 case has the highest current density. This is because the bipolar plate prepared with MWCNT-AEO400 has the highest volume conductivity. However, it is still lower than the maximum current density of the single cell having graphite bipolar plates, i.e. only graphite powder without resin, the maximum current density of which is 1.613 A/cm².

1. A method for preparing a fuel cell composite bipolar plate, which comprises:
a) melt compounding polypropylene resin and graphite powder to form a melt compounding material, the graphite powder content ranging from 60 wt % to 95 wt % based on the total weight of the graphite powder and the polypropylene resin, wherein the polypropylene resin is a homopolymer of propylene or a random copolymer of 75-99 wt % propylene and 1-25 wt % of ethylene, butylenes or hexalene, and wherein 0.01-15 wt % polymer-grafted carbon nanotubes by acyl chlorination-amidization reaction, based on the weight of the polypropylene resin, are added during the melt compounding;
b) molding the melt compounding material containing the polymer-grafted carbon nanotubes from step a) to form a bipolar plate having a desired shaped at 100-250° C. and 500-4000 psi.

2. The method as claimed in claim 1, wherein said polymer-grafted carbon nanotubes by acyl chlorination-amidization reaction are prepared by a process comprising the following steps: 1) reacting carbon nanotubes with a strong acid under refluxing to form acidified carbon nanotubes; 2) reacting the acidified carbon nanotubes from step 1) with thionyl chloride (SOCl₂) to obtain acyl-chlorination carbon nanotubes having —COCl bounded to surfaces thereof; 3) conducting an amidization reaction between said acyl-chlorination carbon nanotubes and a terminal-amine-containing oligomer resulting from a ring-opening reaction between a polyether amine and an epoxy resin to obtain polymer-grafted carbon nanotubes by acyl chlorination-amidization reaction.

3. The method as claimed in claim 2, wherein said epoxy resin has an epoxide equivalent weight of 50-6000 g/eq.

4. The method as claimed in claim 3, wherein said epoxy resin has two terminal epoxide groups.

5. The method as claimed in claim 3, wherein said epoxy resin has multiple terminal epoxide groups.

6. The method as claimed in claim 4, wherein said epoxy resin is diglycidyl ether type epoxy resin, diglycidyl ester type epoxy resin or a polyol type epoxy resin.

7. The method as claimed in claim 5, wherein said epoxy resin is tetraglycidyl ether of diamino diphenyl methane or novolac type epoxy resin.

8. The method as claimed in claim 3, wherein said epoxy resin is an alkene epoxy resin with an epoxide group at a main chain end thereof, an alkene epoxy resin with an epoxide group on a branch chain thereof, an alkene epoxy resin with an epoxide group on a main chain thereof, or an alkene epoxy resin with epoxide groups on a main chain and a branch chain thereof.

9. The method as claimed in claim 2, wherein the polyether amine is polyether diamine having two terminal amino groups, and having a weight-averaged molecular weight of 200-4000.

10. The method as claimed in claim 9, wherein the polyether diamine is poly(propylene glycol)-bis-(2-aminopropyl ether), poly(butylene glycol)-bis-(2-aminobutyl ether) or poly(oxypropylene)-backboned diamines.

11. The method as claimed in claim 2, wherein the polyether amine is polyether triamine having three terminal amino groups or a dentrimer amine.

12. The method as claimed in claim 2, wherein said strong acid in step 1) is nitric acid, hydrogen chloride, sulfuric acid, organic acid or a mixture thereof.

13. The method as claimed in claim 2, wherein said acyl-chlorination in step 2) is carried out at 25-100° C. for a period of 48-96 hours.

14. The method as claimed in claim 13, wherein said acyl-chlorination in step 2) is carried out at 60-80° C. for a period of 65-79 hours.

15. The method as claimed in claim 1, wherein said molding in step b) comprises disposing a metallic net in a mold and introducing the melt compounding material from step a) into said mold.

16. The method as claimed in claim 1 further comprising pulverizing the melt compounding material from step a) to form a melt compounding powder, and wherein step b) comprises placing the melt compounding powder in a mold.

17. The method as claimed in claim 1, wherein the polypropylene resin has a crystallinity of 15-70%.

18. The method as claimed in claim 17, wherein the polypropylene resin has a crystallinity of 30-50%.

19. The method as claimed in claim 1, wherein the polypropylene resin has a melt flow index of 10-50 g/10 min.

20. The method as claimed in claim 1, wherein the polypropylene resin is the homopolymer of propylene.

21. The method as claimed in claim 1, wherein the polypropylene resin is the random copolymer.

22. The method as claimed in claim 21, wherein the polypropylene resin is the random copolymer of propylene and ethylene.

23. The method as claimed in claim 1, wherein said carbon nanotubes are single-walled, double-walled or multi-walled carbon nanotubes, carbon nanohorns or carbon nanocapsules.

24. The method as claimed in claim 23, wherein said carbon nanotubes are single-walled, double-walled or multi-walled carbon nanotubes having a diameter of 1-50 nm, a length of 1-25 μm, a specific surface area of 150-250 m²g⁻¹, and an aspect ratio of 20-2500 m²/g.

25. The method as claimed in claim 1, wherein said melt compounding in step a) is carried out by using a high shear blender.

26. The method as claimed in claim 1, wherein said molding in step b) is an extrusion molding or injection molding.

27. The method as claimed in claim 1, wherein during the melt compounding in step 1) 0.01-10 wt % of an electrically conductive filler is added, based on the weight of the polypropylene resin, wherein said electrically conductive filler is selected form the group consisting of carbon fiber, carbon black, metal plated carbon fiber, metal plated carbon black, carbon nanotube (CNT), modified CNT, and a mixture thereof.

28. The method as claimed in claim 2, wherein said oligomer has a weight-averaged molecular weight of 1000-10000 g mol^{-l}.

29. The method as claimed in claim 1, wherein the melt compounding in step 1) is carried out in a Brablender at 100-250° C. and with a speed of 30-150 rpm.

30. The method as claimed in claim 1, wherein during the melt compounding in step 1) 1-5 wt % of an additional thermoplastic resin is added, based on the weight of the polypropylene resin.
